(19) United States
(12) Patent Application Publication
(10) Pub. No.: US 2024/0307248 A1
(43) Pub. Date: Sep. 19, 2024

(54) SUPPORT SYSTEM FOR VISUALLY IMPAIRED CHILDREN

(71) Applicant: Sheila Boggs, Cincinnati, OH (US)

(72) Inventor: Sheila Boggs, Cincinnati, OH (US)

(21) Appl. No.: 18/605,221

(22) Filed: Mar. 14, 2024

Related U.S. Application Data
(60) Provisional application No. 63/490,021, filed on Mar. 14, 2023.

(51) Int. Cl. A61H 3/00

(52) U.S. Cl. CPC A61H 3/00; A61H 2003/007; A61H 2201/1633

(57) ABSTRACT

A support system for providing hand-under-hand therapy to a visually-impaired and/or a hearing-impaired child includes a securing portion and a stabilizing portion of a harness. The securing portion has a closure and an anchor. The stabilizing portion has a closure and an attachment member. The attachment member of the stabilizing portion of the harness attaches to the anchor of the securing portion of the harness.

### CROSS-REFERENCE TO RELATED APPLICATIONS

The present application claims priority to U.S. Provisional Application Ser. No. 63/490,021, filed on Mar. 14, 2023, the entire disclosure of which is incorporated herein by reference in its entirety.

### TECHNICAL FIELD

The present application relates generally to devices for aiding visually impaired children and in particular to support seats and harnesses to assist caregivers when providing therapy to those children.

### BACKGROUND

Children who are visually impaired and also are hearing impaired or who have other disabilities can benefit from therapy that is provided by a caregiver placing their hands underneath the child's hands to guide them through the exercise. So-called “hand-under-hand” therapy enables the child's brain to develop in such a way that enhances the sense of touch to compensate for the lack of sensory information being received by the eyes and ears. Developing a child's sense of touch in this way can be challenging, especially when the child is not physically capable, for example, of sitting up or keeping their back straight in order to perform the tasks that are part of a given exercise.

### SUMMARY

Exemplary embodiments of a support system to aid a caregiver in providing hand-under-hand therapy to a visually-impaired and/or hearing-impaired child and methods of supporting a visually-impaired and/or a hearing-impaired child are disclosed herein.

A support system for providing hand-under-hand therapy to a visually-impaired and/or a hearing-impaired child includes a securing portion and a stabilizing portion of a harness. The securing portion has a closure and an anchor. The stabilizing portion has a closure and an attachment member. The attachment member of the stabilizing portion of the harness attaches to the anchor of the securing portion of the harness.

A method of supporting a visually-impaired and/or a hearing-impaired child for providing hand-under-hand therapy includes steps of: wrapping a securing portion of a harness around the child and closing a closure of the securing portion, wrapping a stabilizing portion of the harness around a caregiver and closing a closure of the stabilizing portion, and attaching one or more attachment members of the stabilizing portion of the harness to one or more anchors of the securing portion of the harness.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 shows a perspective view of a child secured to a caregiver via an exemplary support seat and harness;

FIG. 2 shows a perspective view of the harness of FIG. 1; and

FIG. 3 shows an exploded view of the support seat of FIG. 1.

### DETAILED DESCRIPTION

The following description refers to the accompanying drawings, which illustrate specific embodiments of the present disclosure. Other embodiments having different structures and operation do not depart from the scope of the present disclosure.

In the following description, for purposes of explanation, numerous specific details are set forth in order to provide a thorough understanding of one or more aspects. It may be evident, however, that such aspect(s) may be practiced without these specific details. Further, it is to be understood that functionality that is described as being carried out by certain system components may be performed by multiple components. Similarly, for instance, a component may be configured to perform functionality that is described as being carried out by multiple components.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Additionally, as used herein, the term “exemplary” is intended to mean serving as an illustration or example of something and is not intended to indicate a preference.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; and X employs both A and B. In addition, the articles “a” and “an” as used in this application and the appended claims should generally be construed to mean “one or more” unless specified otherwise or clear from the context to be directed to a singular form.

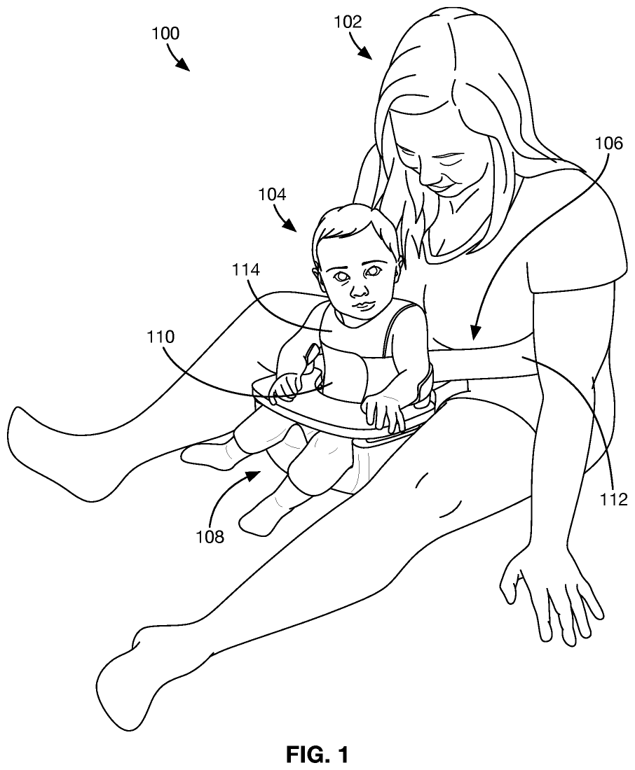

Referring now to FIGS. 1-3, an example of a support system 100 in use by a caregiver 102 to support a child 104 is shown. The support system 100 includes a harness 106 and an optional seat 108. The harness 106 includes a securing portion 110 for securing the child 102 and a stabilizing portion 112 for attaching to the caregiver 104. The child 102 can optionally wear a support vest 114 to help the child 102 sit-up straight before they have the torso strength to do so on their own, thereby enabling hand-under-hand therapy at younger ages to train the child's brain as early as possible. The securing portion 110 can be wrapped around or otherwise secured to the child 102 or attached to the support vest 114. The stabilizing portion 112 of the harness 106 is wrapped around the caregiver 104 and attached to the securing portion 110 to secure the child 102 in front of the caregiver 104 with the back of the child 102 against the stomach of the caregiver 104. In this position, the child 102 is supported by the harness 106 in a sitting position in front of the caregiver 104 whose hands are free to reach out and engage in hand-under-hand exercises with the child 102. In one example of a support system 100, the support vest 114 and securing portion 110 are formed as a single piece of material so that the securing portion 110 takes on the form of a support vest 114 and can be attached to the stabilizing portion 112.

The securing portion 110 can be formed from a flexible material so that the securing portion 110 can be wrapped around the child 102 and closed securely via a closure 116 that is adjustable and releasable. The adjustable closure 116 secures the securing portion 110 around the child 102 in an adjustable and releasable manner so that the securing portion 110 can accommodate differently sized children in a comfortable manner. The ability to easily release the closure 116 enables the securing portion 110 to be released after the caregiver 104 has completed the therapy session.

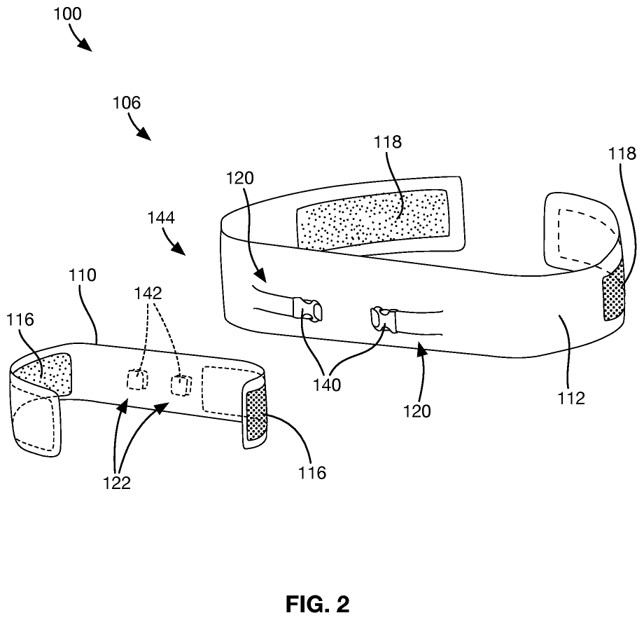

The closure 116 of the securing portion 110 can take on a wide variety of forms, such as, for example, a pair of corresponding buckles, snaps, buttons, laces, or the like. In the example shown in FIG. 2, the closure 116 is provided by a hook side of a hook-and-loop material attached to one end of the securing portion 110 and a loop side of the hook-and-loop material attached to the other end of the securing portion 110. Overlapping and pressing together the hook and the loop sections of the closure 116 forms a releasable connection between both ends of the securing portion 110.

The stabilizing portion 112 can be similarly formed from a flexible material and is wrapped around the caregiver 104 and closed securely via a closure 118 that is adjustable and releasable. The adjustable closure 118 secures the stabilizing portion 112 around the caregiver 104 in an adjustable and releasable manner so that the stabilizing portion 112 can accommodate different caregivers in a comfortable manner. The ability to easily release the closure 118 enables the stabilizing portion 112 to be released after the caregiver 104 has completed the therapy session.

The closure 118 of the stabilizing portion 112 can take on a wide variety of forms, such as, for example, a pair of corresponding buckles, snaps, buttons, laces, or the like. In the example shown in FIG. 2, the closure 118 is provided by a hook side of a hook-and-loop material attached to one end of the stabilizing portion 112 and a loop side of the hook-and-loop material attached to the other end of the stabilizing portion 112. Overlapping and pressing together the hook and the loop sections of the closure 118 forms a releasable connection between both ends of the stabilizing portion 112.

The securing portion 110 of the harness 106 is releasably attached to the stabilizing portion 112 of the harness 106. The attachment between the securing portion 110 and the stabilizing portion 112 is achieved via one or more attachment members 120 of the stabilizing portion that correspond and can be attached to one or more anchors 122 of the securing portion 110. The attachment members 120 connect to the anchors 122 to maintain a secure and stable connection between the caregiver 104 wearing the stabilizing portion 112 and the child 102 wearing the securing portion 110 so that the caregiver's hands are free to provide hand-under-hand therapy without requiring the child 102 to be able to support themselves.

The one or more attachment members 120 releasably attach to the one or more anchors 122 so that the securing portion 110 can be wrapped around the child 102 when the child is independent if it is more convenient to do so. In some uses of the support system 100, it may be more convenient to form connections between the attachment members 120 and the anchors 122 prior to wrapping the securing portion 110 around the child 102 and/or the stabilizing portion 112 around the caregiver 104.

As can be seen in FIG. 2, the attachment members 120 can include a strap or pair of straps ending in a first connector 140 of a releasable attachment mechanism 144. The anchors 112 include a second connector of the releasable attachment mechanism 144. The first and second connectors 140, 142 of the releasable attachment mechanism 144 are connected together to form a secure connection between one of the one or more attachment members 120 and one of the one or more anchors 122. The first and second connectors 140, 142 of the releasable attachment mechanism 144 can be take on a wide variety of forms, such as, for example, buckles, snaps, hook-and-loop material, or other means of forming a repeatable connection.

The attachment members 120 and anchors 122 can have an adjustable position or length to facilitate connection more easily between the first connectors 140 of the one or more attachment members 120 and second connectors 142 of the one or more anchors 122. In one implementation, the anchor 122 includes one or more loops of material through which the one attachment members 120 is routed through before connecting to another attachment member 120 or before being secured to the stabilizing portion 112.

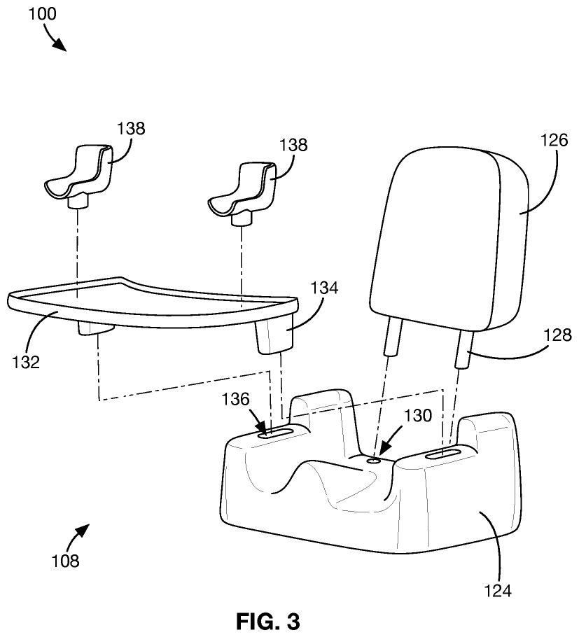

Referring now to FIG. 3, an optional seat 108 is shown in an exploded view to illustrate the various optional and removable features of the seat 108. The seat 108 includes a base 124 on which the child 102 sits. The base 124 of the seat 108 provides the child 102 with a more comfortable place to sit and elevates the child 102 to a height that may be more comfortable for the caregiver 104. In some implementations, the base 124 can be adjusted to different heights to accommodate different sized children and caregivers. Adjusting the height of the base 124 is achieved by including supports (e.g., feet or legs) that extend downward to raise the seat 108 off of the floor.

An optional seat back 126 can be removably attached to the base 124 to provide additional support to the child 102 sitting on the seat 108. The seat back 126 can be removably attached to the base 124 in a wide variety of ways, such as, for example, with one or more posts 128 extending from the seat back 126 and into receptacles 130 of the base 124 as shown in FIG. 3, or in any other suitable means such as with clips, clamps, fasteners, magnets, or the like. The seat back 126 can also be integrally formed with the base 124.

A tray 132 can also be secured to the base 124 to provide a play area directly in front of the child 102. Like the seat back 126, the tray 132 can be removably attached to the base 124 with one or more protrusions 134 extending from the tray 132 that can be inserted into receptacles 136 of the base 124. The tray 132 can be attached to the base 124 in a wide variety of ways, such as, for example, slots, clasps, latches, magnets, fasteners, or any combination thereof. Alternatively, the tray 132 can be attached to the removeable seat back 126 or be integrally formed with the seat back 126.

Optional arm rests or pommels 138 can be secured to the tray 132 to support the child's arms, as shown in FIG. 1. The arm rests 138 are cupped and are open towards the top and the front of the arm rest 138 so that the arm rests 138 support the elbows of the child 102. Supporting the elbow of the child 102 helps to orient the arms of the child 102 towards the front of the tray 132 and prohibits lateral movement of the elbows so that the hands of the child 102 are positioned in a desirable location for the hand-to-hand therapy to be conducted. The arm rests 138 can be connected to the tray 132 in a wide variety of ways, such as, for example, via receptacles (not shown) in the tray 132 for receiving the arm rest 138. The arm rests 138 can also include magnets for attaching to the tray 132 that can include a metal sheet embedded therein for attracting the magnets.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

While various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed:

1. A support system for providing hand-under-hand therapy to a visually-impaired and/or hearing-impaired child, the support system comprising:
a securing portion of a harness, the securing portion comprising a closure and an anchor;
a stabilizing portion of the harness, the stabilizing portion comprising a closure and an attachment member;
wherein the attachment member of the stabilizing portion of the harness attaches to the anchor of the securing portion of the harness.

2. The support system of claim 1, wherein the anchor comprises at least one half of a buckle and the attachment member comprises the other half of the buckle.

3. The support system of claim 1, wherein the anchor comprises one half of a hook-and-loop fastener and the attachment member comprises the other half of a hook-and-loop fastener.

4. The support system of claim 1, wherein the anchor comprises a loop of material and the attachment member comprises a strap for extending through the loop of material of the anchor.

5. The support system of claim 1, wherein the closure of the securing portion comprises a hook-and-loop fastener.

6. The support system of claim 1, wherein the closure of the stabilizing portion comprises a hook-and-loop fastener.

7. The support system of claim 1, wherein the securing portion comprises a support vest.

8. The support system of claim 1, further comprising a seat, the seat comprising a base and at least one of a seat back, a tray, and a pair of arm rests.

9. The support system of claim 8, wherein the seat back is a removable seat back that comprises a downwardly extending post configured to be received in a receptacle of the seat back.

10. The support system of claim 8, wherein the seat back is integrally formed with the base.

11. The support system of claim 8, wherein the tray is a removable tray that comprises a downwardly extending protrusions configured to be received in a receptacle of the base.

12. The support system of claim 8, wherein the tray is a removable tray configured to attached to the seat back.

13. The support system of claim 8, further comprising a pair of arm rests.

14. The support system of claim 13, wherein the arm rests comprise magnets for magnetically attaching to a metal plate formed within the tray.

15. A method of supporting a visually-impaired and/or a hearing-impaired child for delivering for providing hand-under-hand therapy, the method comprising:
wrapping a securing portion of a harness around the child and closing a closure of the securing portion;
wrapping a stabilizing portion of the harness around a caregiver and closing a closure of the stabilizing portion; and
attaching one or more attachment members of the stabilizing portion of the harness to one or more anchors of the securing portion of the harness.

16. The method of claim 15, wherein the step of attaching the one or more attachment members to the one or more anchors is performed before the step of wrapping the securing portion around the child.

17. The method of claim 15, wherein the step of attaching the one or more attachment members to the one or more anchors is performed before the step of wrapping the stabilizing portion around the caregiver.

18. The method of claim 15, wherein the securing portion comprises a support vest.

19. The method of claim 18, further comprising attaching an attachment member of the stabilizing portion to an anchor of the support vest.

20. The method of claim 15, further comprising placing the child in a seat, the seat comprising a base and at least one of a seat back, a tray, and a pair of arm rests.
